(19) United States
(12) Patent Application Publication
(10) Pub. No.: US 2001/0033233 A1
(43) Pub. Date: Oct. 25, 2001

(54) Device and method for product monitoring and management

(76) Inventors: Klaus Jentsch, Oberding (DE); Frank Kriebel, Lichtenberg (DE); Thomas Seidowski, Dresden (DE)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/738,965

(22) Filed: Dec. 15, 2000

(30) Foreign Application Priority Data
Mar. 10, 2000 (DE) 10011827.5
Nov. 30, 2000 (DE) 100 59 539.1

(51) Int. Cl. G08C 19/12

(52) U.S. Cl. 340/870.17; 340/870.28

(57) ABSTRACT

A device for product monitoring and management is applicable in or on a product and includes transmitter/receiver means wherein data relating to the product may be stored, wherein the data relating to the product may be written into and read from the transmitter/receiver means free of contact with the aid of external write-read means. The device moreover includes sensor means for monitoring a temporally variable condition parameter of the product and transmitting data corresponding to a currently prevailing condition to the transmitter/receiver means in dependence on a detected value of the temporally variable condition parameter. The data corresponding to the currently prevailing condition are written into the transmitter/receiver means in response to transmission from the sensor means. Furthermore a method for product monitoring and management is disclosed.

The present invention concerns a device and a method for product monitoring and management in accordance with the preambles of claims 1 and 12.

From DE-A-196 21 179 a device and a method for product management in accordance with the preambles of claims 1 and 12 are known, wherein a transponder is arranged on a sample container such as, for example, a blood bag. By means of an external device, data relating to a blood product are stored in the transponder. In a central laboratory, the data stored in the transponder may be read out from the transponder with the aid of another external device and used for handling stocks, allocation of the blood products contained in the sample containers to work stations, and lab diagnostic examination. Following a lab diagnostic examination of the blood product, data relating to the blood product may in turn again be stored in the transponder, with the possibility of these data then also containing measured lab values.

An advantage achieved through the above described manner of proceeding resides in the possibility of low-cost processing of blood products. Moreover it is not necessary to draw up request lists for respective lab diagnostic examinations inasmuch as data indicating what lab diagnostic examinations are to be carried out on a respective blood product may be stored in the transponder. Although management of the blood products and of data relating to respective blood products may be performed with high reliability and ease in the above mentioned manner of proceeding, it is only conditionally suited for monitoring blood products, for only data relating to the blood product are stored in the transponder and may be read therefrom. The above mentioned document only refers to the handling of products while not providing any indications that it might be desirable to monitor products, e.g., during their course of transport from one location to another, or during storage.

Accordingly, it is the object of the present invention to furnish a device and a method for product monitoring and management, whereby reliable product monitoring may be carried out.

This object is attained through the measures indicated in claim 1 with respect to the device, and through the measures indicated in claim 12 with respect to the method.

More precisely, a device in accordance with the invention for product monitoring and management may be applied in or on a product and includes transmitter/receiver means wherein data relating to the product may be stored. The data relating to the product may be written into and read from the transmitter/receiver means free of contact with the aid of external write-read means. The device moreover includes sensor means for monitoring a temporally variable condition parameter of the product and transmitting data corresponding to a currently prevailing condition to the transmitter/receiver means in dependence on a detected value of the temporally variable condition parameter. The data corresponding to the currently prevailing condition are written in the transmitter/receiver means in response to transmission from the sensor means.

In accordance with the invention it was understood that it is advantageous for product monitoring and management to detect a temporally variable condition parameter of the product and to write data corresponding to a currently prevailing condition into the transmitter/receiver means.

On account of the above mentioned measures it is possible to process not only the data relating to the product but also data corresponding to the currently prevailing condition, thereby enabling, for example, quality control of the product without high expenditure or high costs being required. Moreover a higher flexibility in product management is obtained due to the data corresponding to the currently prevailing condition.

Moreover the above mentioned measures create the possibility of reliable monitoring of the products, for not only data relating to the products, but also data corresponding to a currently prevailing condition may be utilized in monitoring, so that various suitable monitoring processes taking these data into account may be performed in different locations.

In accordance with one development of the present invention, the data corresponding to the currently prevailing condition and stored in the transmitter/receiver means are readable with the aid of the external device. The data corresponding to the currently prevailing condition may thus be used in external processing.

In accordance with another development, the transmitter/receiver means is a transponder. As a transponder does not require a separate energy supply source, a simple design of the device may therefore be achieved.

In accordance with another development, the sensor means detect as the temporally variable condition parameter of the product a temperature of the product, an environmental temperature present around the product, impacts with respect to the product, a radiation value of the product or an environment of the product, a lapsed time, or any combinations of these.

In accordance with another development, the device includes a receptacle for the product which may, e.g., be a soft bag.

In accordance with another development, the sensor means and the transmitter/receiver means may be attached on the receptacle with the aid of a label. The data corresponding to the currently prevailing condition may thus be written directly into the transmitter/receiver means in response to transmission from the sensor means.

In accordance with another development, the sensor means may be provided separate from the receptacle. The data corresponding to the currently prevailing condition may be written into the transmitter/receiver means with the aid of the external device in response to transmission from the sensor means.

In accordance with another development of the present invention, the product is a blood or pharmaceutical product, a genetic engineering product, a biotechnological product, an edible product, an organ or any good whatsoever.

The present invention equally furnishes a method for product monitoring and management having features which are equivalent to those with respect to the above described device for product monitoring and management.

Moreover it is possible with the device according to the invention and external write-read means to furnish a system for product monitoring and management having features which are equivalent to those with respect to the above described device for product monitoring and management.

The present invention shall in the following be explained in more detail by way of embodiments and by reference to the enclosed drawing, wherein:

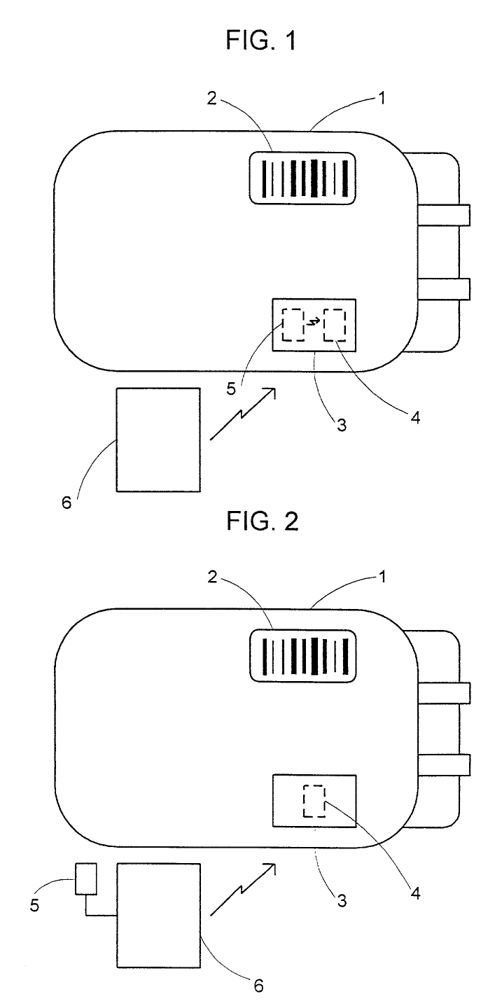

FIG. 1 is a schematic representation of a device in accordance with a first embodiment of the present invention; and

FIG. 2 is a schematic representation of a device in accordance with a second embodiment of the present invention.

It should be noted that, although the embodiments described hereinbelow relate to application of the present invention to a blood bag, the present invention is not limited to this application. The present invention may rather be applied to any products, with its application being particularly meaningful where it is a matter of handling products necessitating monitoring of their condition in order to ensure a good quality of the products.

Moreover the present invention is not limited to being applied on a receptacle such as, e.g., a blood bag. The present invention may rather also, e.g., be implanted directly in a product or attached directly on this product if the respective product has an appropriate form.

In the following, the description of a first embodiment of the present invention shall be given.

FIG. 1 shows a device in accordance with the first embodiment of the present invention.

In FIG. 1, reference symbol 1 designates a blood bag, reference symbol 2 designates a bar code label, reference symbol 3 designates a label, reference symbol 4 designates a transponder, reference symbol 5 designates a temperature sensor, and reference symbol 6 designates external transponder write-read means.

Although in this embodiment of the present invention the transponder 4 is used as transmitter/receiver means, any other transmitter/receiver means such as a bluetooth chip may be used as long as it is possible to write data into the transmitter/receiver means and read them therefrom.

Moreover, although in this embodiment of the present invention the external transponder write-read means 6 are used, it is equally possible to use any other external write-read means, such as external bluetooth chip write-read means, as long as these are capable of writing these data into the transmitter/receiver means and reading them free of contact.

Finally, although in this embodiment of the present invention the temperature sensor 6 is used as sensor means, any other sensor means may be used as long as they are capable of detecting a value of a temporally variable condition parameter to be monitored. Such temporally variable condition parameters to be monitored may, besides the temperature, for example be any temporally variable condition parameters enabling a statement concerning a quality, perishability etc. of the blood or pharmaceutical products. This may, for example, be a temporally variable composition of the blood or pharmaceutical product. The respective sensor means used may be both active sensor means requiring a separate energy supply source, but also passive sensor means not requiring a separate energy supply source and working, for example, in the manner of a transponder with externally coupled, external energy.

The following is a description of the construction of the first embodiment of the present invention.

In accordance with the representation of FIG. 1, a bar code label 2 is attached to a blood bag 1, with the bar code storing data related to a blood product contained in the blood bag 1. Such a bar code label 2 may be produced, e.g., following completion of a withdrawal of blood in which the blood bag 1 is used. Provision of the bar code label 2 is, however, not compulsory.

Moreover a label 3 is attached on the blood bag, in which label the transponder 4 and the temperature sensor 5 are embedded. Although in FIG. 1 only one transponder 4 and one temperature sensor 5 are shown, several transponders 4 and/or several temperature sensors 5 and/or several other sensors may be embedded in the label 2. The label 2 is preferably attached to the blood bag 1 with the aid of an adhesive layer, with the adhesive layer also serving to support a mechanism, connections, and an antenna of the transponder 4. Finally, separate from the blood bag 1, the external transponder write-read means 6 are provided which are connected with processing means not shown here, such as apparatus for monitoring withdrawal of blood, a calculator or the like in a cordless fashion or with the aid of a suitable connection such as an optically or electrically conductive connection. The external processing means may furthermore in turn be connected to a computer network in a cordless fashion or by means of a suitable connection such as an electrically or optically conductive connection.

In the following, a description of the manner of functioning of the first embodiment of the present invention shall be given.

When a blood product is introduced into the blood bag 1, data relating to this blood product are written free of contact into the transponder 4 with the aid of the external transponder write-read means 6. It is equally possible to write data relating to the blood product and known in advance into the transponder 4 with the aid of the external transponder write-read means prior to introduction of the blood product into the blood bag. These data will then be available in subsequent monitoring and handling processes and can be read from the transponder with the aid of respective transponder write-read means 6 and subjected to another processing, supplemented by further data, modified, or erased. Such monitoring and handling processes may, for example, be a transport of the blood bag 1, storing of the blood bag 1, retrieval of the blood bag 1 from storage, a predetermined lab examination of the blood product contained in the blood bag 1, destruction of the blood product contained in the blood bag 1, etc. Apart from these data relating to the blood product, the temperature sensor 5 may at any point of time and at any time intervals and in any location detect a value of a currently prevailing temperature of the blood product contained in the blood bag 1, a value of the temperature currently prevailing in the surroundings of the blood product, or both, and directly write it/them into the transponder 4, either free of contact or via a suitable connection such as an electrically or optically conductive connection. A respective detected value of the temperature, or in general a respective detected value of a temporally variable condition parameter of the blood product may then also be used and processed at any point of time, similarly to the above described data relating to the blood product.

The external transponder write-read means 6 are connected with processing means not shown here, such as apparatus for monitoring withdrawal of blood, a calculator connected to a computer network or the like, either wireless or through a suitable conductive line such as, e.g., an electrically or optically conductive connection as described above, so that the external transponder write-read means 6 permit both writing data from processing means into the transponder 4 and reading from the latter, in order to carry out processing such as described above. Moreover with the aid of such processing means and the external transponder write-read means 6, for example observance of a prescribed cold chain may be monitored with the aid of the data corresponding to respective detected temperature values.

In any processes encompassing withdrawal of blood, a transport, storing, a processing of a blood product, a lab examination of the blood product, a destruction of the blood product etc., the above described device creates the possibility of writing the data relating to the blood product onto the transponder 4, processing them by an external calculator or computer network, modifying and/or supplementing them, and re-writing them into the transponder 4. Moreover the temperature of the blood product is monitored with the aid of the temperature sensor 5, so that, for example, observance of the cold chain during the lifetime of the blood product may be monitored.

The above described device is excellently suited for use in monitoring and handling blood products in most variegated locations such as, for example, in blood collection facilities, during transport, during storage, in a clinic or hospital, etc. Thanks to the possibility of acquiring the data stored on respective transponders of respective blood bags 1 located in a particular location such as, e.g., a clinic or hospital, these data can suitably be managed, processed and/or monitored by means of a computer network present in this location.

If external transponder write-read means 6 are positioned in different places in such a location, it is moreover possible to check and/or detect the respective current whereabouts of respective blood bag 1.

In the following, the description of a second embodiment of the present invention shall be given.

The second embodiment of the present invention is identical—with the exception of the modifications described hereinbelow—with the first embodiment of the present invention, so that the explanations made above concerning the first embodiment of the present invention are also valid with respect to the second embodiment of the present invention.

FIG. 2 shows a device in accordance with the second embodiment of the present invention.

The second embodiment of the present invention differs from the first embodiment of the present invention in that the temperature sensor is not provided while embedded in the label 3 but separate from the blood bag 1. The above mentioned writing of a respective value of a currently prevailing temperature is not carried out directly in this embodiment of the present invention, but indirectly through the external device in such a manner that the detected value of the currently prevailing temperature is transmitted, either contact-free or via a conductive connection, from the temperature sensor 5 to the external transponder write-read means 6, to then be written by the latter into the transponder 4.

The further manner of functioning of the second embodiment and the further options of processing the data relating to the blood product and the data corresponding to the currently prevailing temperature are identical with those of the first embodiment of the present invention, so that a further description thereof shall be omitted here.

The following is a description of developments of the first and second embodiments of the present invention.

Each transponder 4 attached to a respective blood bag 1 may exhibit a specific serial number. If, now, several blood bags 1 are present in a particular location such as a storage location, it is possible to select, with the aid of an external transponder write-read means 6 while taking into consideration a respective serial number of a blood bag 1, which transponder 4 of a particular blood bag 1 is to be addressed by the external transponder write-read means 6, in order to store data therein or read therefrom. By means of a like serial number it is correspondingly possible to prevent a collision of data and/or inadvertently addressing a wrong transponder 4.

Moreover by means of a like unambiguous serial number, several transponders 4 to be queried may be queried simultaneously by allocating particular serial numbers to a group of transponders 4 to be queried, in order to store data in them or read from them. In the case of the second embodiment of the present invention there consequently exists the possibility, for example, of acquiring an environmental temperature during a storage or a transport by means of the temperature sensor 5 and to simultaneously write into all transponders 4 which are attached to blood bags 1 located in the same environment.

Each external transponder write-read means 6 may furthermore comprise several channels, whereby the option is created of querying several transponders 4 at the same time so as to write various data into them or read from them.

Although the present invention has been described by referring to two embodiments which relate to blood or pharmaceutical products, the present invention is not limited thereby. Any products whatsoever may be monitored or handled, for example including genetic engineering products, biotechnological products, edible products, organs or any other goods and objects to be monitored and/or administrated. Temporal condition parameters of the like products may, besides those described for the first and second embodiments, furthermore also encompass, e.g., impacts with respect to the product, a radiation value of the product or of an environment surrounding the product, such as a radioactive radiation, a perishability condition of the product, expiration dates of the products, a lapsed time, or any combinations of these.

In the case of a sensitive good, for example, it is possible to write into the transmitter/receiver means with respect to the temporally variable condition parameter of impacts, thus enabling quality control of a transport, for example, which further allows for clarification of warranty claims if damage to the product is caused as a result of impacts. Moreover a lapsed transport and/or storage period may be used as the temporally variable condition parameter.

It can also be seen that the present invention may be applied to any product to be monitored and/or handled. The respective temporal condition parameter used may be selected flexibly depending on the purpose of use in question.

An essential advantage is achieved by the present invention, for example, in monitoring and/or administrating perishable products, such as victuals, for the respective present condition of the perishable products may be detected rapidly and safely through the device and the method according to the invention and taken into account. It is therefore easily possible, e.g., to monitor observance of a cold chain or of an expiration date.

1. A device for product monitoring and management, said device being applicable in or on a product and including transmitter/receiver means wherein data relating to the product may be stored, wherein said data relating to the product may be written into and read from said transmitter/receiver means free of contact with the aid of external write-read means,
characterized by
sensor means for monitoring a temporally variable condition parameter of the product and transmitting data corresponding to a currently prevailing condition to said transmitter/receiver means in dependence on a detected value of said temporally variable condition parameter,
said data corresponding to the currently prevailing condition being written into said transmitter/receiver means in response to transmission from said sensor means.

2. The device according to claim 1, characterized in that said data corresponding to the currently prevailing condition and stored in said transmitter/receiver means are readable with the aid of said external device.

3. The device according to claim 1 or 2, characterized in that said transmitter/receiver means is a transponder.

4. The device according to any one of the preceding claims, characterized in that said sensor means detect as said temporally variable condition parameter of the product a temperature of the product, a temperature of an environment present around the product, impacts with respect to the product, a radiation value of the product or of an environment surrounding the product, a perishability condition of the product, expiration dates of the product, a lapsed time, or any combinations thereof.

5. The device according to any one of the preceding claims, characterized by a receptacle for the product.

6. The device according to claim 5, characterized in that said receptacle is a soft bag.

7. The device according to claim 5 or 6, characterized in that said sensor means and said transmitter/receiver means are attached to said receptacle by means of a label.

8. The device according to claim 7, characterized in that said data corresponding to the currently prevailing condition are written directly into said transmitter/receiver means in response to transmission from said sensor means.

9. The device according to claim 5 or 6, characterized in that said sensor means are provided separate from said receptacle.

10. The device according to claim 9, characterized in that said data corresponding to the currently prevailing condition are written into said transmitter/receiver means with the aid of said external device in response to transmission from said sensor means.

11. The device according to any one of the preceding claims, characterized in that the product is a blood or pharmaceutical product, a genetic engineering product, a biotechnology product, an edible product, an organ, or any good whatsoever.

12. A method for product monitoring and management by means of a device applicable in or on a product and including transmitter/receiver means wherein data relating to the product may be stored, wherein said data relating to the product may be written into and read from said transmitter/receiver means free of contact with the aid of external write-read means,
characterized by the following steps:
monitoring a temporally variable condition parameter of the product and transmitting data corresponding to a currently prevailing condition to said transmitter/receiver means in dependence on a detected value of said temporally variable condition parameter; and
writing said data corresponding to the currently prevailing condition into said transmitter/receiver means in response to transmission from said sensor means.

13. The method according to claim 12, characterized in that said data corresponding to the currently prevailing condition and stored in said transmitter/receiver means are readable with the aid of said external device.

14. The method according to claim 12 or 13, characterized in that a transponder is used as said transmitter/receiver means.

15. The method according to any one of claims 12 to 14, characterized in that said sensor means detect as said temporally variable condition parameter of the product a temperature of the product, a temperature of an environment present around the product, impacts with respect to the product, a radiation value of the product or of an environment surrounding the product, a perishability condition of the product, expiration dates of the product, a lapsed time, or any combinations thereof.

16. The method according to any one of claims 12 to 15, characterized in that the product is in advance introduced into a receptacle of said device for monitoring and acquisition of products.

17. The method according to claim 16, characterized in that a soft bag is used as said receptacle.

18. The method according to claim 16 or 17, characterized in that said sensor means and said transmitter/receiver means are in advance attached on said receptacle by means of a label.

19. The device according to claim 18, characterized in that said data corresponding to the currently prevailing condition are written directly into said transmitter/receiver means in response to transmission from said sensor means.

20. The method according to claim 16 or 17, characterized in that said transmitter/receiver means are attached on said receptacle in advance with the aid of a label, and that sensor means separate from said receptacle are used as said sensor means.

21. The method according to claim 20, characterized in that said data corresponding to the currently prevailing condition are written into said transmitter/receiver means with the aid of said external device in response to transmission from said sensor means.

22. The device according to any one of claims 12 to 20, characterized in that the product is a blood or pharmaceutical product, a genetic engineering product, a biotechnology product, an edible product, an organ, or any good whatsoever.
